(19) United States
(12) Patent Application Publication
(10) Pub. No.: US 2025/0306586 A1
(43) Pub. Date: Oct. 2, 2025

(54) INPUT DEVICE, INPUT METHOD, SERVER, AND SYSTEM

(71) Applicant: HONDA MOTOR CO.,LTD., Tokyo (JP)

(72) Inventors: Naoto NAKAMURA, Saitama (JP); Wei SONG, Saitama (JP); Andrii PYDIN, Saitama (JP); Naoto SUZUKI, Tokyo (JP)

(21) Appl. No.: 18/619,180

(22) Filed: Mar. 28, 2024

(51) Int. Cl. G05D 1/224

(52) U.S. Cl. CPC G05D 1/2246

(57) ABSTRACT

An input device comprising: a display unit which displays a map including a path along which a movable working machine can travel; and an input unit for a user to input a first instruction to display an environment object indicating an environment related to the path along with the path on the map displayed on the display unit, wherein the display unit displays the environment object on a position corresponding to the path on the map when the first instruction is input to the input unit.

### BACKGROUND

### 1. Technical Field

The present invention relates to an input device, an input method, a server, and a system.

### 2. Related Art

Patent Document 1 discloses a technique to create a driving path for an autonomously moving robot, considering the information related to traffic rules incorporated into the map information.

### Prior Art Document

### Patent Document

Patent Document 1: Japanese Patent Application Publication No. 2022-178183

### SUMMARY

In a first aspect of the present invention, an input device is provided. The input device includes a display unit which displays a map including a path along which a movable working machine can travel. The input device includes an input unit for a user to input a first instruction to display, on the map displayed on the display unit, an environment object indicating the environment related to the path along with the path. The display unit displays the environment object at the position corresponding to the path on the map when the first instruction is input to the input unit.

The first instruction may include an instruction to indicate to start the first instruction and an instruction to specify on the map the path displayed along with the environment object.

The input unit may further input a second instruction for the user to select a particular type of environment related to the path among a plurality of the environments of different types.

The input unit may input an operation predetermined by the user concerning the position on the path on the map. When the predetermined operation is input into the input unit, the display unit may display options for the user to select a particular type of environment among the plurality of environments. The input unit may input an instruction from the user to select a particular type of environment related to the path among the options.

The environment related to the path may include the travel rule of the path.

The travel rule may include at least one of prohibiting entry to the path and limiting the travel speed on the path.

The environment related to the path may include a road surface state of the path.

The input unit may further input from the user a third instruction to stop displaying the environment object displayed on the display unit. When the third instruction is input to the input unit, the display unit may stop displaying the environment object displayed on the map.

The input unit may input from the user the position of the path on the map at which the environment object is to be displayed. When the position which has been input into the input unit is off the path on the map and the position which has been input into the input unit is within a predetermined range from the path, the display unit may display, on the display unit, the environment object along with the path.

The display unit may display a lattice pattern object by superimposing it on the map. The first instruction may include an instruction to specify the position of one compartment of the lattice pattern object. When at least part of the path is included within one compartment of the lattice pattern object instructed by the first instruction, the display unit may display the environment object on the position corresponding to the path on the map.

The movable working machine may be an unmanned vehicle which performs autonomous navigation.

In a second aspect of the present invention, a server is provided. The server can communicate with an input device which displays a map including a path along which the movable working machine can travel. In the input device, the environment information indicating the environment related to the path is input to the map by the user. The server includes a calculation unit to calculate the path along which the movable working machine travels. The server includes a communication unit to receive from the input device the position information indicating the position on the map to which the environment information is input by the user in the input device. The calculation unit re-calculates a new path along which the movable working machine should travel, based on the position information and position information of the path when the communication unit receives the position information from the input device.

The environment related to the path may include the travel rule on the path.

The communication unit may further receive the information indicating the state of the path and may transmit to the input device the map further including the information indicating the state of the path when it receives the information indicating the state of the path.

The communication unit may receive information indicating the state of the path detected by the movable working machine.

The information indicating the state of the path may include at least any of the information indicating the existence of a puddle on the path, the information indicating the existence of mud on the path, the information indicating the existence of bump or dent on the path, and the information indicating the degree of the gradient of the path.

The movable working machine may be an unmanned vehicle which performs autonomous navigation.

In a third aspect of the present invention, an input method is provided. The input method includes a step of displaying a map including a path along which the movable working machine can travel. The input method includes a step of obtaining, by the input unit, a first instruction to display an environment object indicating the environment related to the path along with the path, on the displayed map from the user. The input method includes a step of displaying the environment object on the position corresponding to the path on the map when the first instruction is input.

In a fourth aspect of the present invention, a system is provided. The system includes any input device described above. The system includes a calculation unit which calculates the path along which the movable working machine travels. The system includes a communication unit which receives from the input device the position information indicating the position on the map to which the information indicating the environment is input by the user in the input device. The calculation unit re-calculates a new path along which the movable working machine should travel, based on the position information and position information of the path when the communication unit receives the position information from the input device.

The summary of the invention described above does not describe all necessary features of the present invention. The present invention may also be a sub-combination of the features described above.

### BRIEF DESCRIPTION OF THE DRAWINGS

FIG. 1 illustrates the overall configuration of the system 10 according to an embodiment.

FIG. 2 schematically illustrates the functional block configuration of the input device 100.

FIG. 3 schematically illustrates the functional block configuration of the server 140.

FIG. 4 schematically illustrates an example of the screen 400 displayed by the display unit 240.

FIG. 5 schematically illustrates an example of the screen 500 displayed by the display unit 240.

FIG. 6 schematically illustrates a first case in which the user 80 performs the first instruction on the screen 600 displayed by the display unit 240.

FIG. 7 schematically illustrates a second case in which the user 80 performs the first instruction on the screen 700 displayed by the display unit 240.

FIG. 8 schematically illustrates another case in which the user performs the first instruction on the screen 800 displayed by the display unit 240.

FIG. 9 schematically illustrates a case in which the user performs the third instruction on the screen 800 displayed by the display unit 240.

FIG. 10 schematically illustrates another case in which the user 80 performs the first instruction on the screen 1000 displayed by the display unit 240.

FIG. 11 schematically illustrates the screen 1100 displayed by the display unit 240 when the map 480 is zoomed in.

FIG. 12 illustrates a data structure of task information managed by the server 140.

FIG. 13 illustrates a method performed in the input unit 210, the server 140, and the movable body 120.

FIG. 14 illustrates an example of a computer 2000 in which a plurality of embodiments of the present invention may be entirely or partially embodied.

### DESCRIPTION OF EXEMPLARY EMBODIMENTS

Hereinafter, the present invention will be described through embodiments of the invention, but the following embodiments do not limit the invention according to claims. In addition, not all of the combinations of features described in the embodiments are essential to the solution of the invention.

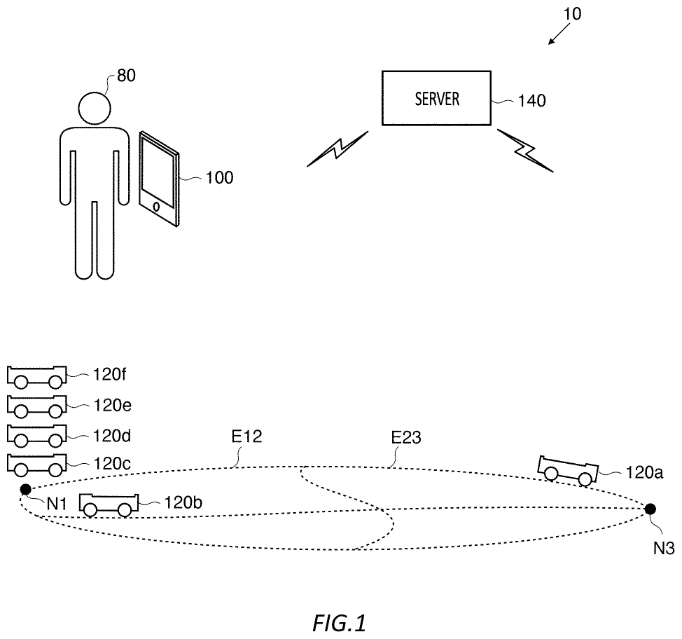

FIG. 1 illustrates the overall configuration of the system 10 according to an embodiment. The system 10 includes the input device 100, the server 140, the movable body 120a, the movable body 120b, the movable body 120c, the movable body 120d, the movable body 120e, and the movable body 120f.

In the present embodiment, the movable body 120a, the movable body 120b, the movable body 120c, the movable body 120d, the movable body 120e, and the movable body 120f are sometimes collectively referred to as the movable body 120. In the present embodiment, the movable body 120 is a movable working machine. In other words, the movable body 120 is a working machine which has a moving function. The movable body 120 is an unmanned vehicle which performs autonomous navigation. The movable body 120 is a vehicle which performs work. As an example, the movable body 120 is a vehicle for carrying a load. The movable body 120 communicates with the server 140 in a wireless manner and sends/receives the information to/from the server 140. The movable body 120 may communicate with the server 140 through a mobile communication standard (such as 3G, 4G, 5G, 6G), wireless LAN and/or Wi-Fi (registered trademark). The communication between the server 140 and the movable body 120 may include communication conducted partly through a communication cable.

The server 140 calculates a path along which the movable body 120 should travel. For example, the server 140 calculates a path along which the movable body 120 should travel based on the work plan of the movable body 120. In the present embodiment, the path along which the movable body 120 can drive is determined according to a plurality of nodes indicating particular points and edges connecting the nodes. The server 140 transmits to the movable body 120 the travel path information indicating a path along which the movable body 120 should travel and the movable body 120 travels along the path along which the movable body 120 should travel based on the travel path information received from the server 140.

For example, the movable body 120 moves from the position of the node N1 to the position of the node N3 through the path precalculated by the server 140. For example, the position of the node N1 is the collection site of a load and the position of the node N3 is a site where the load is to be unloaded. The movable body 120 collects the load at the position of the node N1, then moves to the position of the node N3 by following the edge E12 and the edge E23 precalculated by the server 140, and performs unloading at the position of the node N3. Subsequently, the movable body 120 returns to the position of the node N1 by following the path precalculated by the server 140.

The input device 100 is an input device for the user 80 to input the environment related to the path along which the movable body 120 can travel. The user 80 is a person who utilizes the input device 100. The input device 100 has a function to display a map including the path along which the movable body 120 can travel. The input device 100 has a function to input the instruction from the user 80 which relates to the environment related to the path along which the movable body 120 can travel on the displayed map.

The input device 100 may be portable electronic equipment. The input device 100 may be a tablet terminal, a smartphone, a mobile phone, a notebook computer, a laptop computer, or the like. The input device 100 may be non-portable electronic equipment. The input device 100 may be a desktop personal computer or the like. The input device 100 may communicate with the server 140 through a mobile communication standard (such as 3G, 4G, 5G, 6G), wireless LAN and/or Wi-Fi (registered trademark). The communication between the server 140 and the movable body 120 may include communication at least partly through a communication cable.

In the present embodiment, the environment related to the path along which the movable body 120 can travel includes the information indicating that travel is prohibited. The user 80 obtains the information indicating the environment related to the path based on the outside information such as the weather information of the area which is set on the moving path of the movable body 120, the information collected by another movable body 120 driving in the area, and/or the like. For example, when it is found that a puddle exists on the path E23, the user 80 inputs the environment information indicating the prohibition of travel along the edge E23 by using the input device 100 to point the position of the edge E23 on the map displayed on the screen of the input device 100. The input of the environment information to the input device 100 may be performed through a touching operation. The input to the input device 100 may be performed by using a pointer device through a mouse operation, a touchpad operation, or the like.

The input device 100 transmits to the server 140 the position information indicating the position on the map pointed by the user 80. When the server 140 receives the position information from the input device 100, it prohibits travel along the edge E23 based on the received position information. The server 140 transmits the map information so that the input device 100 displays the environment object indicating the prohibition of travel along the edge E23. For example, the server 140 transmits to the input device 100 the information indicating the position of the environment object on the map to display, on the edge E23, the environment object indicating the prohibition of travel along the edge E23.

When the server 140 receives the position information from the input device 100, it further re-calculates the path along which the movable body 120 should travel. For example, when it is scheduled that the movable body 120c moves from the node N1 to N3 by traveling along the edge E12 and the edge E23, the server 140 re-calculates a path which does not include the edge E23 as the path along which the movable body 120c should travel.

The system 10 of the present embodiment can provide a user interface with which to input the environment information related to the path along which the movable body 120 can travel. Furthermore, the path along which the movable body 120 should travel can be re-calculated based on the environment information which is input by the user 80. In this way, the movable body 120 can be moved efficiently.

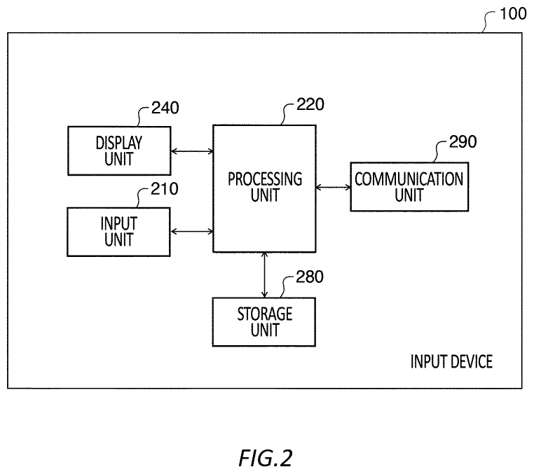

FIG. 2 schematically illustrates the functional block configuration of the input device 100. The input device 100 includes the input unit 210, the processing unit 220, the display unit 240, the storage unit 280, and the communication unit 290.

The processing unit 220 is implemented, for example, with a computational processing device including a processor. The storage unit 280 is implemented to include a non-volatile storage medium. The processing unit 220 performs processing by using information such as a program stored in the storage unit 280. The processing unit 200 or the input device 100 may be entirely implemented with a computer including a CPU, an ROM, an RAM, an I/O, a bus, and the like.

The display unit 240 displays a map which includes a path along which the movable body 120 can travel. The input unit 210 is for the user to input the first instruction to display the environment object indicating the environment related to the path along with the path on the map displayed on the display unit 240. The display unit 240 displays the environment object at the position corresponding to the path on the map when the first instruction is input to the input unit 210.

The first instruction may include an instruction to indicate to start the first instruction and an instruction to specify on the map the path to be displayed along with the environment object.

The input unit 210 may further input a second instruction for the user to select a particular type of environment related to the path among a plurality of environments of different types.

The input unit 210 may input an operation predetermined by the user for a position on the path on the map. When a predetermined operation is input to the input unit 210, the display unit 240 may display an option for the user to select a particular type of environment among a plurality of environments. The input unit 210 may input the instruction from the user to select a particular type of environment related to the path among options.

The environment related to the path may include travel rule of the path. The travel rule may include at least one of prohibiting entry to the path and limiting the travel speed on the path. The travel rule may include limiting the moving direction on the path.

The environment related to the path may include a road surface state on the path.

The input unit 210 may further input a third instruction from the user to stop displaying the environment object displayed on the display unit 240. When the third instruction is input to the input unit 210, the display unit 240 may stop displaying the environment object displayed on the map.

The input unit 210 may input from the user the position on the map of the path for which the environment object is to be displayed. When the position which is input to the input unit 210 is off the path on the map and the position which is input to the input unit 210 is within a predetermined range from the path, the display unit 240 may display the environment object along with the path on the display unit 240.

The display unit 240 may display a lattice pattern object by superimposing it on the map. The first instruction may include an instruction to specify the position of one compartment of the lattice pattern object. When at least part of the path is included in one compartment of a lattice pattern object instructed by the first instruction, the display unit 240 may display the environment object at the position corresponding to the path on the map.

The input unit 210 may further input a fourth instruction to zoom in the map or a fifth instruction to zoom out the map. When the fourth instruction is input to the input unit 210, the display unit 240 may display the map and environment object by increasing their sizes. When the fifth instruction is input to the input unit 210, the display unit 240 may display the map and the environment object by reducing their sizes.

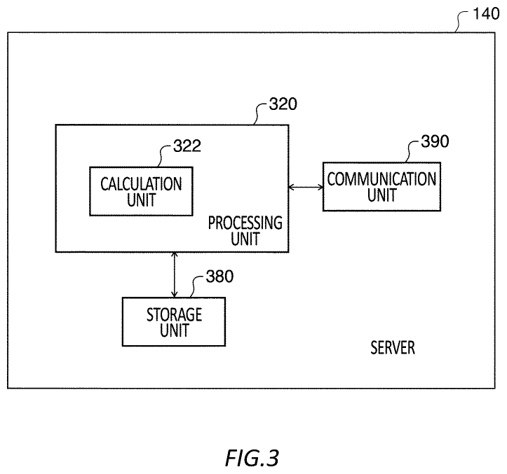

FIG. 3 schematically illustrates the functional block configuration of the server 140. The server 140 includes a processing unit 320, a storage unit 380, and a communication unit 390.

The processing unit 320 is implemented, for example, by a computational processing device including a processor. The storage unit 380 is implemented by including a non-volatile storage medium. The processing unit 320 performs the process by using the information such as a program stored in the storage unit 380. The processing unit 320 or the server 140 may be entirely implemented with a computer including a CPU, an ROM, an RAM, an I/O, a bus, and the like.

The server 140 can communicate with the input device 100 which displays the map including the path along which the movable body 120 can travel. In the input device 100, the environment information indicating the environment related to the path is input by the user to the map. The calculation unit 322 calculates a path along which the movable body 120 travels. The communication unit 390 receives from the input device 100 the position information indicating the position on the map for which the user has input the environment information in the input device 100. The calculation unit 322 re-calculates a new path along which the movable body 120 should travel based on the position information and the position information of the path when the communication unit 390 receives the position information from the input device 100.

The environment related to the path may include travel rule of the path.

The communication unit 390 may receive the information indicating the state of the path. The communication unit 390 may transmit to the input device 100 the map further including the information indicating the state of the path when it receives the information indicating the state of the path.

The communication unit 390 receives the information indicating the state of the path detected by the movable body 120. The information indicating the state of the path may include at least any of the information indicating the existence of a puddle on the path, the information indicating the existence of mud on the path, the information indicating the existence of a bump or dent on the path, and the information indicating the degree of the gradient of the path.

The movable body 120 may detect the existence of a puddle or a bump or dent using an RGB-d camera, for example. For example, the movable body 120 may detect the existence of mud by measuring the friction force between the movable body 120 and a road surface (the fore-aft force acting between a wheel of the movable body 120 and the road surface). The movable body 120 may detect the road surface state by measuring, with a sensor, the vehicle state affected by a road surface state, such as driving torque, slip rate, acceleration, and the like. The movable body 120 may detect the state of the road surface based on the intensity of the reflected light of the laser which is emitted by LiDAR and reflected on the road surface.

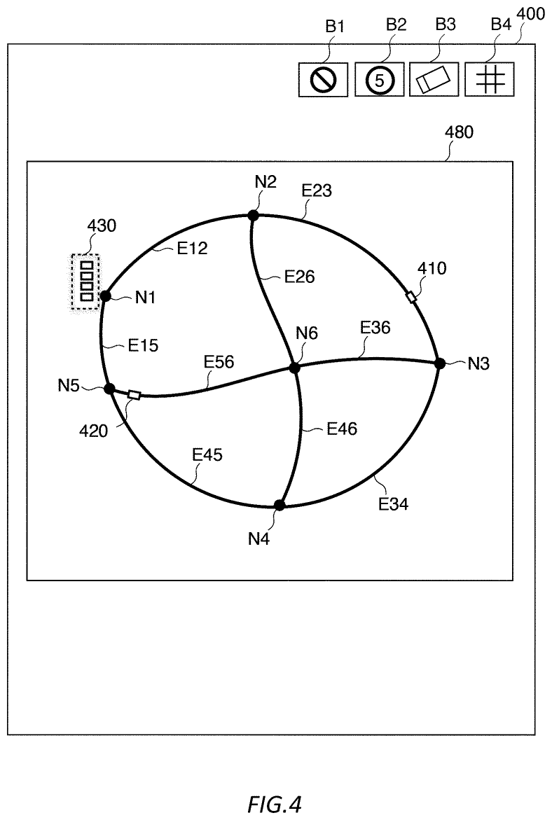

FIG. 4 schematically illustrates an example of the screen 400 displayed by the display unit 240. The screen 400 displays the map 480, the vehicle object 410, the vehicle object 420, and the vehicle object 430, and the operation object B1, the operation object B2, the operation object B3, and the operation object B4. The map 480 includes objects which indicate the positions of the node N1, node N2, node N3, node N4, node N5, and node N6. The map 480 includes objects of the edge E12, edge E23, edge E34, edge E45, edge E15, edge E26, edge E36, edge E46, and edge E56. In the present embodiment, to prevent redundancy of description, when the objects of nodes and edges displayed on the display unit 240 are described, they are sometimes referred to as “node N1”, “edge E12”, and the like, omitting the term “object”.

The edge E12 is the edge connecting the node N1 and the node N2. The edge E23 is the edge connecting the node N2 and the node N3. The edge E34 is the edge connecting the node N3 and the node N4. The edge E45 is the edge connecting the node N4 and the node N5. The edge E15 is the edge connecting the node N1 and the node N5. The edge E26 is the edge connecting the node N2 and the node N6. The edge E36 is the edge connecting the node N3 and the node N6. The edge E46 is the edge connecting the node N4 and the node N6. The edge E56 is the edge connecting the node N5 and the node N6.

The vehicle object 410, the vehicle object 420, and the vehicle object 430 are displayed such that they are superimposed on the map 480. The vehicle object 410 indicates the current position of the movable body 120a on the move on the map 480. The vehicle object 420 indicates the current position of the movable body 120b on the move on the map 480. The vehicle object 430 indicates the current position of the movable body 120c, the movable body 120d, the movable body 120e, and the movable body 120f at rest on the map 480.

Each of the operation object B1 and the operation object B2 is an object used by the user 80 for the first instruction related to the environment. The operation object B1 and the operation object B2 as a whole also serve as the objects used by the user 80 for the second instruction to select a particular type of environment related the path among a plurality of environments of different types. The operation object B3 is the object used by the user 80 for the third instruction related to an environment object. The operation object B4 is the object used for instructing to display a lattice pattern object on the map 480 as a part of the first instruction.

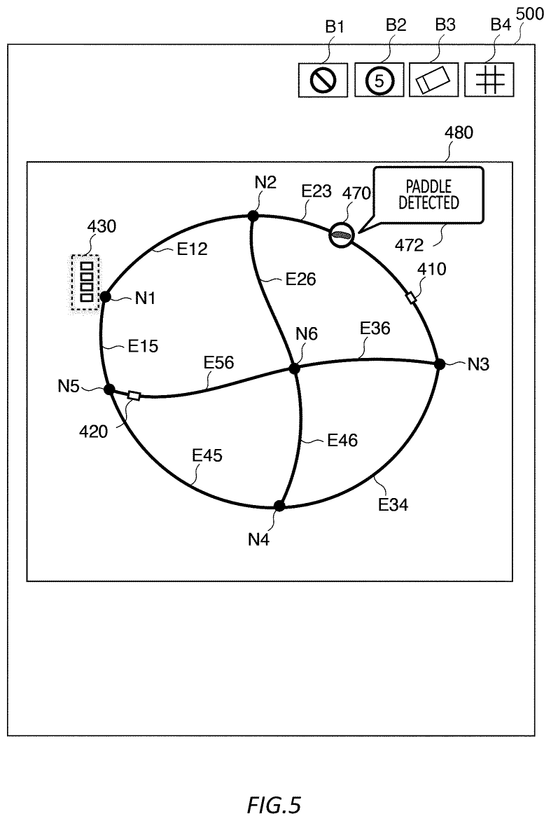

FIG. 5 schematically indicates an example of the screen 500 displayed by the display unit 240. The screen 500 is an example of the screen which is displayed when the server 140 receives the information indicating the state of the path. Specifically, the screen 500 indicates the screen which is displayed when a puddle is detected on the edge E23.

“The state of the path” may be detected by the movable body 120. For example, the movable body 120 may detect the state of the road surface based on the intensity of the reflected light of the laser which is emitted by the LiDAR (Light Detection and Ranging) function included in the movable body 120 and reflected on the road surface. The movable body 120 transmits to the server 140 the information indicating the detected state of the road surface as the information indicating the state of the path. “The state of the path” may be detected based on the image captured by a fixed point camera provided near the path along which the movable body 120 can drive and the detected state of the path may be transmitted from the fixed point camera to the server 140.

When the movable body 120a detects the existence of a puddle by using a LIDAR function during the travel along the edge E23, the path state information indicating the detection of the puddle and the detected position of the puddle is transmitted to the server 140. When the server 140 receives the path state information, it transmits to the input device 100 the path state information that a puddle has been detected and the position information on the map 480 indicating the detected position of the puddle.

Once the display unit 240 receives the path state information and the position information, it displays the object 470 based on the received path state information and the position information. The object 470 is the object with a visual feature representing a puddle. The object 470 is displayed at the position on the map 480 where the existence of the puddle is detected on the link E23. The display unit 240 displays the indication that the puddle has been detected. Based on the path state information received from the server 140, the display unit 240 may further display, for a predetermined period, the object 472 indicating that the puddle has been detected.

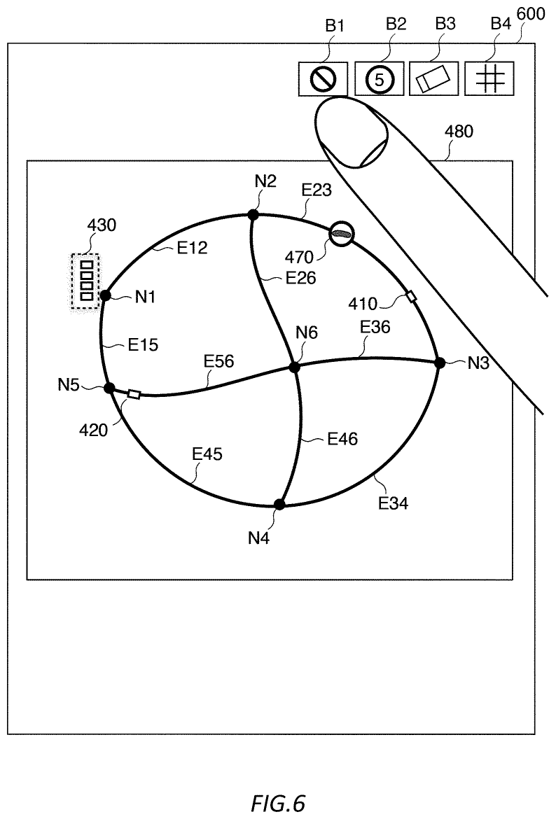

FIG. 6 schematically illustrates a first case in which the user 80 performs the first instruction on the screen 600 displayed by the display unit 240. Specifically, FIG. 6 illustrates a case in which the user 80 performs an operation on the screen 600 by touching with a finger on the display position of the operation object B1 on the display unit 240. The touching on the operation object B1 is the instruction to indicate the start of the first instruction.

Here, the operation object B1 and the operation object B2 represent the traffic rules on the path. More specifically, the operation object B1 is the object which indicates to specify the path where the entry of the movable body 120 is prohibited. The operation object B2 is the object which indicates to specify the path where the travel speed of the movable body 120 is limited.

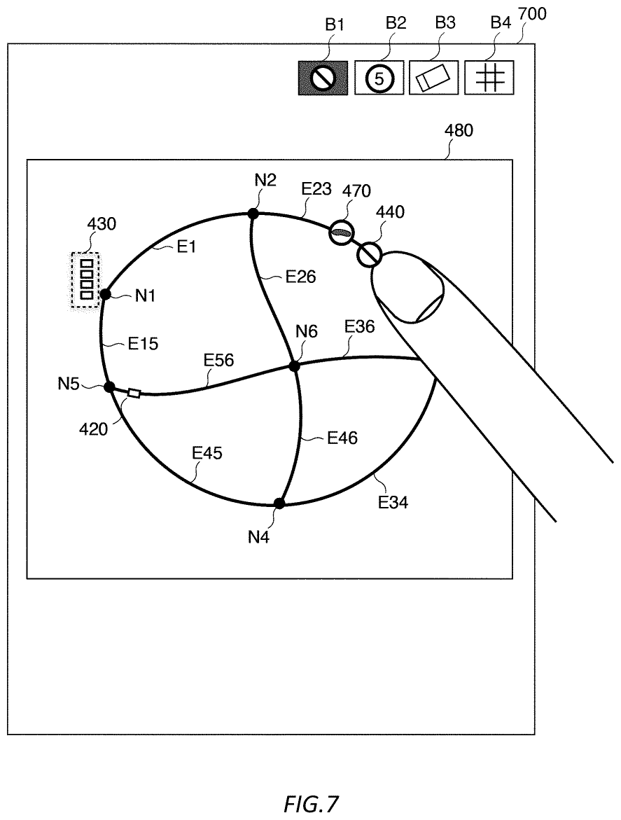

FIG. 7 schematically illustrates a second case in which the user 80 performs the first instruction on the screen 700 displayed by the display unit 240. Specifically, FIG. 7 illustrates a case in which a finger is detached from the display unit 240 near the display position of the edge E23 while the screen 700 is displayed, or a case in which a finger touches the display unit 240 near the display position of the edge E23.

As an example, with reference to FIG. 6, when the user 80 touches the display position of the operation object B1 and then the user 80 directly slides the finger on the display unit 240, the display unit 240 changes the display position of the object 440 following the movement of the finger. The object 440 is an example of the environment object. When a finger of the user 80 performs the input operation by detaching the finger from the display unit 240 near the display position of the edge E23, the input unit 210 accepts the input operation as the instruction to specify the edge E23 displayed along with the environment object on the map 480. In this manner, the display position of the object 440 is fixed on the position from which the finger of the user 80 has been detached. In this manner, the display unit 240 and the input unit 210 can accept the first instruction through a so-called drop and drop operation from the operation object B1.

As another example, with reference to FIG. 6, when the user 80 touches the display position of the operation object B1 and then detaches a finger from the display unit 240 for the moment and the user 80 performs an input operation by touching the display unit 240 with a finger near the display position of the edge E23, the processing unit 220 accepts the input operation as the instruction to specify the edge E23 displayed along with the environment object on the map 480. In this way, the display position of the object 440 in the screen 700 is fixed to the position at which a finger of the user 80 touches the display unit 240. In this manner, the display unit 240 and the input unit 210 can accept the first instruction by operations other than a drag and drop from the operation object B1. In this manner, the user 80 can perform the instruction to display the environment object corresponding to the operation object B1 along with the path.

The operation on the operation object B1 was described with reference to FIG. 7. The user 80 can cause the display unit 240 to display the environment object corresponding to the operation object B2 along with the path by performing on the operation object B2 an operation similar to the operation on the operation object B1. As described with reference to FIG. 7, the user 80 can input on the map 480 displayed on the display unit 240 the first instruction to display the environment object indicating the environment related to the path along with the path.

Although the operation with a finger of the user 80 was described with reference to FIG. 7, a similar operation can also be performed by various input devices such as a mouse, a trackpad, a keyboard, or the like.

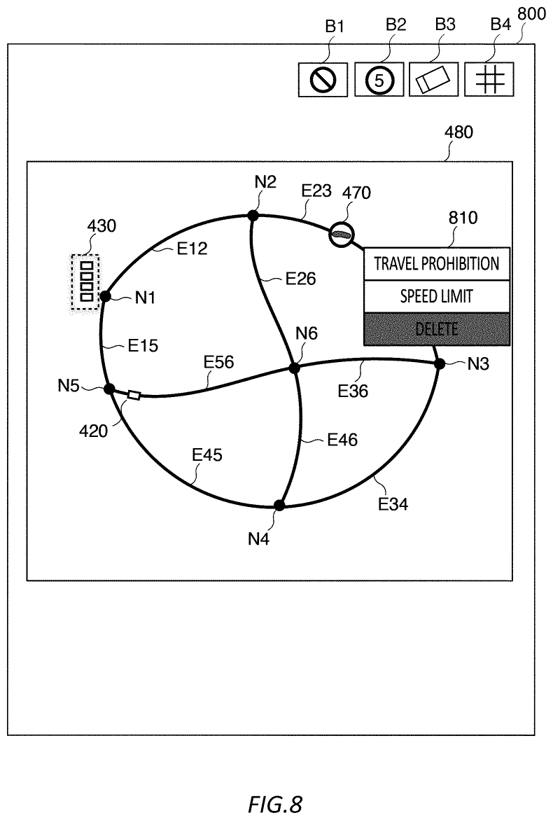

FIG. 8 schematically indicates another case in which the user performs the first instruction on the screen 800 displayed by the display unit 240. FIG. 8 is a figure for describing the operation performed by the user 80 by long-pressing the display unit 240 to display the environment object on the display unit 240. The long-press operation is an example of a predetermined operation obtained as a part of the first instruction.

When the user 80 performs the long-press operation near the edge E23, the display unit 240 displays the option 810. The option 810 includes the selection items of “travel prohibition” and “speed limitation” as valid selection items. The “travel prohibition” indicates one environment among a plurality of types of environments related to the path. Specifically, the “travel prohibition” indicates the environment corresponding to the operation object B1. The “speed limitation” indicates another environment among a plurality of types of environments related to the path. Specifically, the “speed limitation” corresponds to the operation object B2. The option 810 is the object to input the second instruction for the user 80 to select a particular type of environment related to the path among a plurality of environments of different types. Specifically, the option 810 is the object for the user 80 to select a particular type of environment among a plurality of environments when a predetermined operation is performed on the input unit 210. In the path where a speed limitation is set, the server 140 transmits the instruction to decelerate and/or accelerate and keep a constant speed to the movable body 120 which is scheduled to drive along the path where the speed limitation is set.

When the user 80 performs the operation to select the selection item of “travel prohibition” in the option 810, the input unit 210 obtains the operation as the instruction to prohibit entry to the edge E23. In this case, the display unit 240 displays the object 440 at the position which has been long-pressed. When the user 80 performs the operation to select the selection item of “speed limitation” in the option 810, the input unit 210 obtains the operation as the instruction to limit the travel speed on the edge E23. In this case, the display unit 240 displays the object corresponding to the operation object B2 at the long-pressed position.

Although the operation with a finger of the user 80 was described with reference to FIG. 8, a similar operation can also be performed by various input devices such as a mouse, a trackpad, a keyboard, or the like.

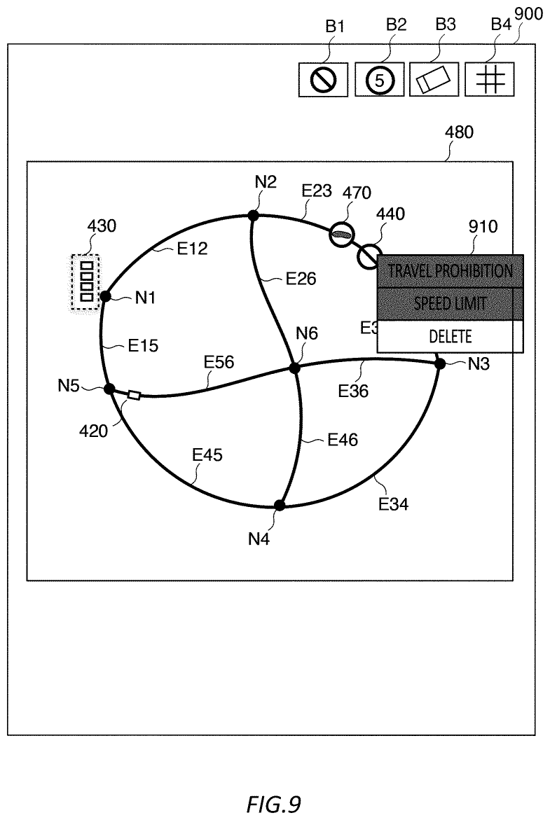

FIG. 9 schematically illustrates a case in which the user performs the third instruction on the screen 800 displayed by the display unit 240. Specifically, FIG. 9 is a figure to describe the operation performed by the user 80 by long-pressing the display unit 240 to stop displaying the environment object.

When the user 80 long-presses near the display position of the object 440, the display unit 240 displays the option 910. The option 910 includes the selection item “delete” as the valid selection item. The “delete” is a selection item to instruct to stop displaying the object 440. In other words, the “delete” is used to input the third instruction to stop displaying the environment object displayed on the display unit 240. When the user 80 performs the operation to select the selection item “delete” in the option 910, the input unit 210 obtains the operation as the instruction to stop displaying the object 440. In this case, the display unit 240 stops displaying the object 440.

The input unit 210 can obtain the instruction to stop displaying the object 440 with the operation on the operation object B3. For example, the input unit 210 may obtain, as the instruction to stop displaying the object 440, the operation to touch the operation object B3, then detach the finger from the display unit 240 for the moment, and then touch the display position of the object 440. Besides, the input unit 210 may obtain, as the instruction to stop displaying the object 440, the operation to touch the operation object B3, then directly slide the finger, and then detach the finger from the display unit 240 at the display position of the object 440.

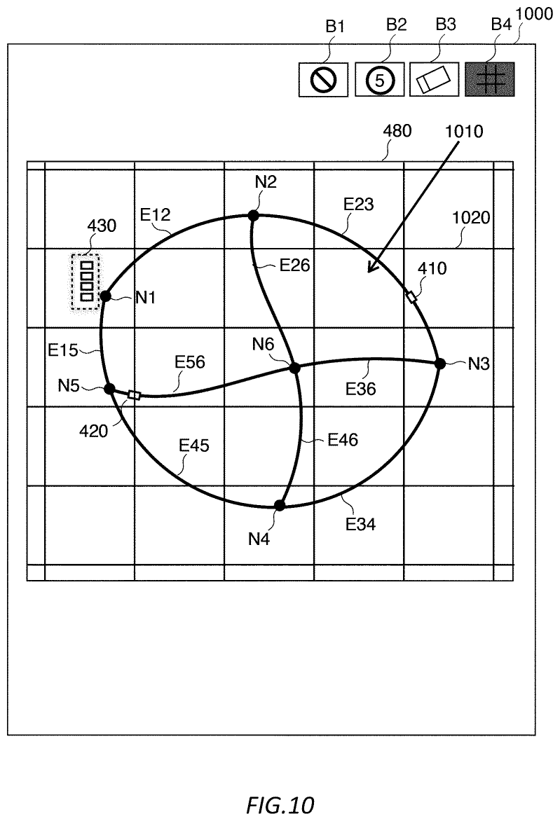

FIG. 10 schematically illustrates another case in which the user 80 performs the first instruction on the screen 1000 displayed by the display unit 240. Specifically, the display unit 240 displays the lattice pattern object 1020 by superimposing it on the map 480. For example, when the user 80 touches the operation object B 4, the display unit 240 displays the lattice pattern object 1020 by superimposing it on the map 480.

When the user 80 performs the operation to touch the position of the compartment 1010, which is one of the lattice pattern object 1020, the input unit 210 obtains the operation as the instruction that the edge E23 displayed in the compartment 1010 is the display target of the environment object. When the user 80 performs the operation to touch the operation object B1 in this state, the input unit 210 obtains the operation as an instruction to prohibit entry to the edge E23. In this case, the display unit 240 displays the object 440 near the display position of the edge E23 or the edge E23.

Similarly, when the user 80 performs the operation to touch the operation object B2, the input unit 210 obtains the operation as the instruction to limit the travel speed on the edge E23. In this case, the display unit 240 displays the object corresponding to the operation object B2 near the display position of the edge E23 or the edge E23. In this manner, when one compartment 1010 of the lattice pattern object 1020 instructed by the first instruction includes at least a part of a path, the display unit 240 displays the environment object on the position corresponding to the path on the map 480.

With reference to FIG. 10, the operation to select the edge which is the display target of the environment object by specifying the lattice pattern object 1020 was described. As another method, the input unit 210 may obtain the instruction that the edge E23 displayed in the closed curve drawn by the user 80 with a finger and the like on the display unit 240 is the display target of the environment object.

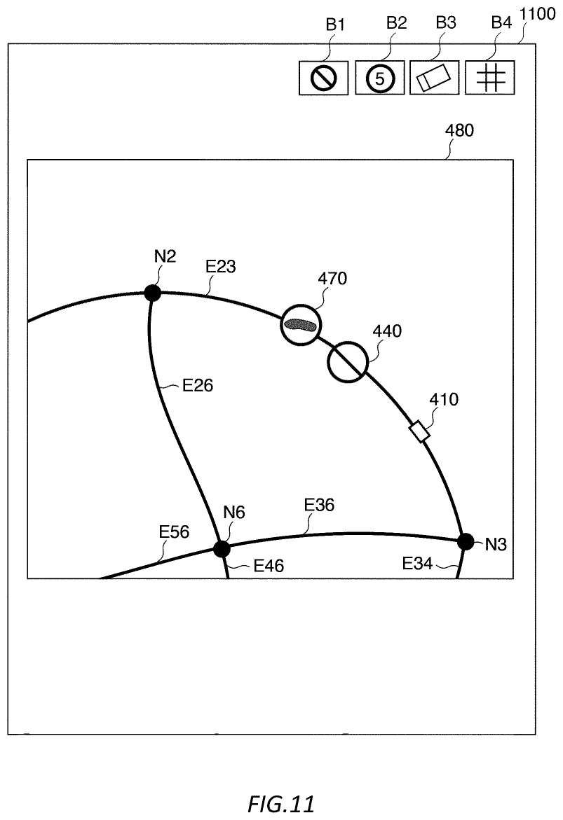

FIG. 11 schematically illustrates the screen 1100 which is displayed by the display unit 240 when the map 480 is zoomed in. When the user 80 performs a pinch-out operation or a pinch-in operation on a region of the map 480 on the screen, the display unit 240 zooms in or zooms out the map 480. The pinch-out operation is an example of the fourth instruction to zoom in the map 480 and the pinch-in operation is an example of the fifth instruction to zoom out the map 480.

When the pinch-out operation is performed on a region of the map 480, the display unit 240 displays the map 480, the object 440, the object 470, and the vehicle object 410 by increasing their sizes. When the zoom in is performed, the magnification rates of the map 480, the environment object, and the vehicle object 410 may be the same.

When the pinch-in operation is performed on a region of the map 480, the display unit 240 displays the map 480, the object 440, the object 470, and the vehicle object 410 by reducing their sizes. In this case, the reduction rates of the map 480, the environment object, and the vehicle object 410 may be the same.

Here, the display unit 240 may display the map 480 and the vehicle object 410 at the same scale. This enables visual recognition by the user 80 with a sense of scale.

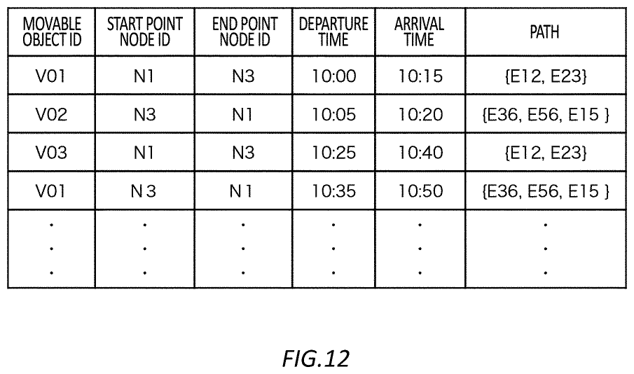

FIG. 12 indicates the data structure of the task information managed by the server 140. The task information includes a movable body ID, a start point node ID, an end point node ID, a departure time, an arrival time, and a path.

The movable body ID indicates the identification information of the movable body 120. The start point node ID indicates the identification information of the node at which the movable body 120 starts moving. The end point node ID indicates the identification information of the node at which the movable body 120 stops moving.

The departure time indicates the time at which the movable body 120 starts moving. In other words, the departure time indicates the time at which the movable body 120 starts moving from the node at which it starts moving. The departure time may be the earliest time at which the movable body 120 can start moving. The arrival time indicates the time at which the movable body 120 starts moving. The arrival time indicates the time at which the movable body 120 should arrive at the node at which it stops moving. The arrival time may be the latest time at which the movable body 120 is scheduled to stop moving. The path indicates the sequence of the edges through which the movable body 120 travels.

The calculation unit 322 refers to the task information to re-calculate the path along which the movable body 120 should travel. For example, when the server 140 receives from the input device 100 the information that the travel along the edge E23 is prohibited at 10:10, the calculation unit 322 determines the movable body 120 scheduled to enter the edge E23 after 10:10 and re-calculates a path which does not involve traveling along E23 as the path along which the determined movable body 120 should travel. In the example of FIG. 11, the calculation unit 322 determines the movable body 120 identified with the movable body ID “V03” as the movable body 120 scheduled to enter the edge E23 after 10:10, and determines a path which involves traveling in the sequence of the edge E12, the edge E26, and the edge E36, for example, as the path along which the determined movable body 120 should travel.

The storage unit 380 of the server 140 may store the information indicating the passageway width of each edge and the vehicle width of the movable body 120. The calculation unit 322 may calculate the path along which the movable body 120 should travel based on the information indicating the passageway width of each edge and the vehicle width of the movable body 120 such that no movable bodies 120 cannot pass each other on the same edge. For example, when the path which involves traveling in the sequence of the edge E12, the edge E26, and the edge E36 is determined as the path along which the movable body 120 identified with the movable body ID “V03” should travel, the movable body 120 identified with the movable body ID “V03” possibly passes the movable body 120 identified with the movable body ID “V01” on the edge E36. When it is determined that the movable body 120 identified with the movable body ID “V03” and the movable body 120 identified with the movable body ID “V01” cannot pass each other on the edge E36 based on the vehicle width of the edge E36, the vehicle width of the movable body 120 identified with the movable body ID “V03”, and the vehicle width of the movable body 120 identified with the movable body ID “V01”, the calculation unit 322 may determine a path which does not involve traveling along the edge E36 as the path along which the movable body 120 identified with the movable body ID “V01” should travel. For example, the path which involves traveling in the sequence of the edge E34, the edge E45, and the edge E15 may be determined as the path along which the movable body 120 identified with the movable body ID “V01” should travel.

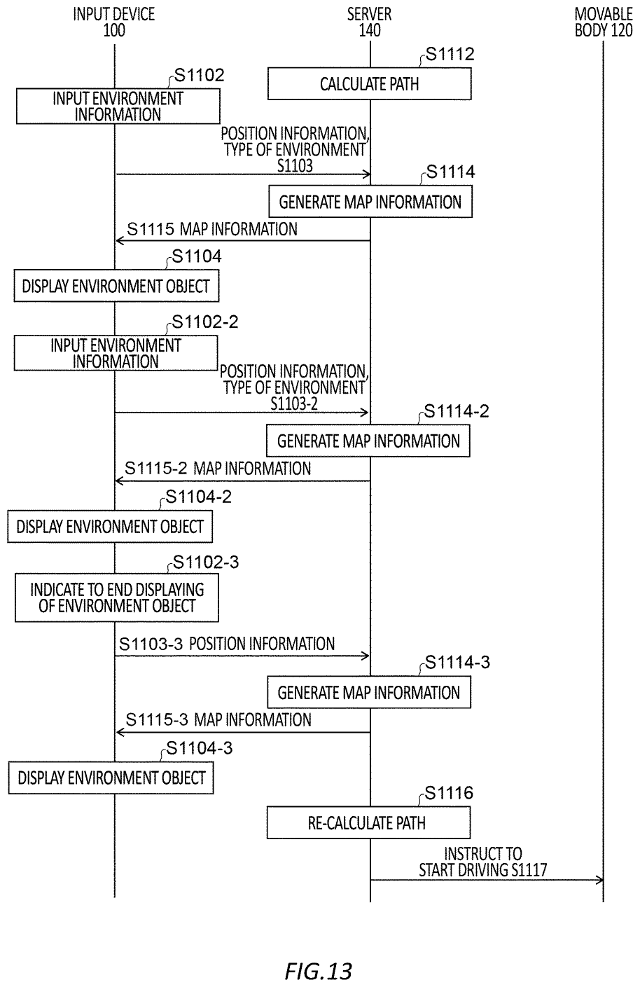

FIG. 13 illustrates a method performed on the input unit 210, the server 140, and the movable body 120. In S1112, the calculation unit 322 calculates the path along which each movable body 120 travels. For example, the calculation unit 322 calculates the path along which each movable body 120 travels based on a work plan.

In S1102, the environment information indicating the environment related to the path is input by the user 80 in the input device 100. The input unit 210 inputs the environment information with a method described with reference to FIG. 6 to FIG. 8, FIG. 10, and the like. The environment information includes the environment type information indicating the type of the environment. The environment information includes the position information on the map 480 into which the environment is input.

In S1103, the communication unit 290 transmits to the server 140 the position information included in the environment information and the environment type information included in the environment information.

In S1114, the processing unit 320 of the server 140 generates map information for the input device 100 to display the map 480 based on the position information and the environment type information included in the environment information received from the input device 100. The map information may include the position on the map 480 at which the environment object is displayed and information indicating the image of the environment object to be displayed on the map 480. The processing unit 320 may compare the position information included in the environment information received from the input device 100 to the position information of each edge stored in the storage unit 380 to determine the closest edge to the position information included in the environment information as the edge for which the environment object is to be displayed. The processing unit 320 may determine any position on the determined edge as the position on the map 480 in which the environment object is displayed.

In S1115, the communication unit 390 transmits to the input device 100 the map information generated in S1114. In S1104, once receiving the map information from the server 140, the input device 100 displays the environment object based on the received map information.

In S1102-2, the environment information indicating a new environment related to the path is input by the user 80 into the input device 100. For example, the input unit 210 inputs the environment information indicating a new environment through an operation object which is different from the operation object used to input the environment information in S1102 among the operation object B1 and the operation object B2 in FIG. 4. The environment information includes the environment type information indicating the type of the environment corresponding to the operation object and the position information on the map 480 into which the environment is input.

In S1103-2, the communication unit 290 transmits to the server 140 the position information included in the environment information and the environment type information included in the environment information.

In S1114-2, the processing unit 320 of the server 140 generates the map information for the input device 100 to display the map 480 based on the position information and the environment type information included in the environment information received from the input device 100. The map information is generated based on the position information and the environment type information received in S1103 and S1103-2. The map information may include the position on the map 480 corresponding to each position information and the information indicating the image of the environment object corresponding to each environment type information.

In S1115-2, the communication unit 390 transmits to the input device 100 the map information generated in S1114-2. In S1104-2, once receiving the map information from the server 140, the input device 100 displays the environment object based on the received map information.

In S1102-3, the instruction to stop displaying the environment object is input by the user 80 in the input device 100. For example, the user 80 operates the operation object B3 in FIG. 4 to specify the position of the environment object to stop displaying. Here, it is assumed that the environment object which the user 80 instructs to stop displaying is the environment object corresponding to the environment information which is input in S1102.

In S1103-3, the communication unit 290 transmits to the server 140 the position information indicating the position on the map 480 instructed by the user 80.

In S1114-3, the processing unit 320 of the server 140 generates the map information for the input device 100 to display the map 480 based on the position information received from the input device 100. The map information is generated based on the position information and the environment type information received in S1103-2. In other words, the map information may include the position on the map 480 corresponding to the position information received in S1103-2 and the information indicating the image of the environment object corresponding to the environment type information received in S1103-2.

In S1115-3, the communication unit 390 transmits to the input device 100 the map information generated in S1114-3. In S1104-3, once receiving the map information from the server 140, the input device 100 displays the environment object based on the received map information. In this way, the display unit 240 displays the environment object based on the input information which is input in S1103-2.

In S1116, the calculation unit 322 re-calculates the path along which the movable body 120 should travel. For example, the calculation unit 322 re-calculates the path along which the movable body 120 should travel as described with reference to FIG. 12 and the like. In the example described with reference to FIG. 13, the calculation unit 322 re-calculates based on the environment information received in S1103-2. The task information stored in the storage unit 380 is updated based on the path re-calculated by the calculation unit 322. In S1117, the communication unit 390 transmits, based on the task information, the instruction to start driving to the movable body 120 whose departure time has arrived.

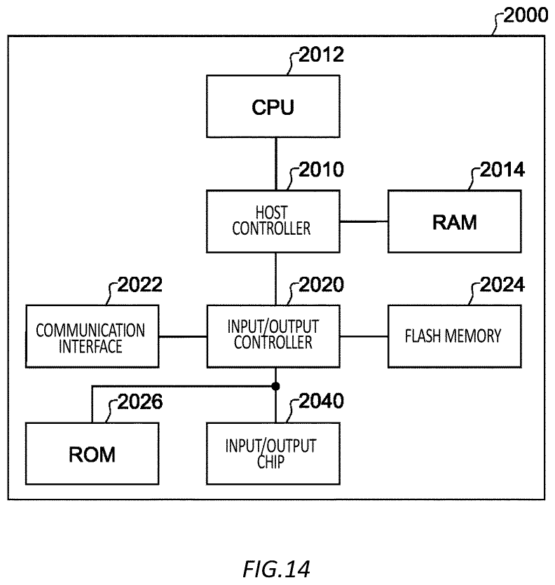

In the system 10 described above, the server 140 performs the calculation of the path along which the movable body 120 should travel. However, as a variation of the system 10, an embodiment may be employed in which the input device 100 performs the calculation of the path along which the movable body 120 should travel. For example, an embodiment may be employed in which the input device 100 performs the processes of S1112 and S1116 in FIG. 14. As another variation of the system 10, an embodiment may be employed in which the input device 100 includes at least a part of other functions included in the server 140 In addition to the function to calculate the path along which the movable body 120 should travel. As another variation of the system 10, an embodiment may be employed in which the input device 100 includes all other functions included in the server 140. In the variation which employs the embodiment in which the input device 100 includes all other functions included in the server 140, the server 140 may only include the input device 100.

FIG. 14 shows an example of a computer 2000 in which a plurality of embodiments of the present invention may be entirely or partially embodied. The program installed in the computer 2000 can cause the computer 2000 to function as each unit of the server or the system according to an embodiment or as a device such as various input devices or each unit of the device, to perform the operation associated with the system or each unit of the system or the device or each unit of the device, and/or perform a process according to an embodiment or a step of the process. Such a program may be executed by a CPU 2012 in order to cause the computer 2000 to execute a particular operation associated with some or all of the processing procedures and the blocks in the block diagrams described herein.

The computer 2000 according to the present embodiment includes the CPU 2012 and a RAM 2014, which are mutually connected by a host controller 2010. The computer 2000 also includes a ROM 2026, a flash memory 2024, a communication interface 2022, and an input/output chip 2040. The ROM 2026, the flash memory 2024, the communication interface 2022, and the input/output chip 2040 are connected to the host controller 2010 via an input/output controller 2020.

The CPU 2012 operates according to programs stored in the ROM 2026 and the RAM 2014, and thereby controls each unit.

The communication interface 2022 communicates with another electronic device via a network. The flash memory 2024 stores a program and data used by the CPU 2012 in the computer 2000. The ROM 2026 stores a boot program or the like executed by the computer 2000 during activation, and/or a program depending on hardware of the computer 2000. The input/output chip 2040 may also connect various input/output units such as a keyboard, a mouse, and a monitor, to the input/output controller 2020 via input/output ports such as a serial port, a parallel port, a keyboard port, a mouse port, a monitor port, a USB port, a HDMI (registered trademark) port.

A program is provided via a network or a computer-readable storage medium such as a CD-ROM, a DVD-ROM, or a memory card. The RAM 2014, the ROM 2026, or the flash memory 2024 is an example of the computer-readable storage medium. The program is installed in the flash memory 2024, the RAM 2014, or the ROM 2026, and executed by the CPU 2012. Information processing written in these programs is read by the computer 2000, and provides cooperation between the programs and the various types of hardware resources described above. A device or a method may be implemented by executing operations or processing of information depending on a use of the computer 2000.

For example, when a communication is executed between the computer 2000 and an external device, the CPU 2012 may execute a communication program loaded in the RAM 2014, and instruct the communication interface 2022 to execute communication processing based on processing written in the communication program. Under the control of the CPU 2012, the communication interface 2022 reads transmission data stored in a transmission buffer processing region provided in a storage medium such as the RAM 2014 or the flash memory 2024, transmits the read transmission data to the network, and writes reception data received from the network into a reception buffer processing region or the like provided on the storage medium.

In addition, the CPU 2012 may cause all or a necessary portion of a file or a database stored in a storage medium such as the flash memory 2024 to be read into the RAM 2014, and execute various types of processing on the data on the RAM 2014. Next, the CPU 2012 writes back the processed data into the storage medium.

Various types of information such as various types of programs, data, a table, and a database may be stored in the storage medium and may be subjected to information processing. The CPU 2012 may execute, on the data read from the RAM 2014, various kinds of processing including various types of operations, information processing, conditional judgement, conditional branching, unconditional branching, information retrieval/replacement, or the like described herein and specified by instruction sequences of the programs, and write back a result into the RAM 2014. In addition, the CPU 2012 may retrieve information in a file, a database, or the like in the storage medium. For example, when multiple entries each having an attribute value of a first attribute associated with an attribute value of a second attribute, is stored in the storage medium, the CPU 2012 may retrieve an entry having a designated attribute value of the first attribute that matches a condition from these multiple entries, and read the attribute value of the second attribute stored in this entry, thereby obtaining the attribute value of the second attribute associated with the first attribute that satisfies a predetermined condition.

The programs or software modules described above may be stored in the computer-readable storage medium on the computer 2000 or in the vicinity of the computer 2000. A storage medium such as a hard disk or a RAM provided in a server system connected to a dedicated communication network or the Internet can be used as the computer-readable storage medium. A program stored in the computer-readable storage medium may be provided to the computer 2000 via a network.

The program which is installed in the computer 2000 and causes the computer 2000 to function as the input device 100 may instruct the CPU 2012 or the like to cause the computer 2000 to function as each unit of the input device 100. The information processing described in these programs is read by the computer 2000 to function as each unit of the input device 100 which is specific means for which software and various hardware resources described above cooperate. These specific means implement computing or processings of information according to the intended use of the computer 2000 in the present embodiment, and the input device 100 is thereby constructed to be specific for the intended use.

A program that is installed into the computer 2000 and makes the computer 2000 function as the server 140 may work on the CPU 2012 and the like to make the computer 2000 function as each unit of the server 140, respectively. The information processing written in these programs are read by the computer 2000 to cause the computer to function as each unit of the server 140, which is a specific means implemented by the cooperation of software and the various types of hardware resources described above. Then, these specific means implement computing or processing of information corresponding to the intended use of the computer 2000 in this embodiment, so that the server 140 is constructed as a specific server corresponding to the intended use.

Various embodiments have been described with reference to the block diagrams and the like. In the block diagrams, each block may represent (1) a step of a process in which an operation is executed, or (2) each unit of the device having a role in executing the operation. A particular step and each unit may be implemented by a dedicated circuit, a programmable circuit supplied with computer-readable instructions stored on a computer-readable storage medium, and/or a processor supplied with computer-readable instructions stored on a computer-readable storage medium. The dedicated circuit may include a digital and/or analog hardware circuit, or may include an integrated circuit (IC) and/or a discrete circuit. The programmable circuit may include a reconfigurable hardware circuit including logical AND, logical OR, logical XOR, logical NAND, logical NOR, and another logical operation, and a memory element such as a flip-flop, a register, a field programmable gate array (FPGA), a programmable logic array (PLA), or the like.

The computer-readable storage medium may include any tangible device capable of storing instructions to be executed by an appropriate device. Thereby, the computer-readable storage medium having instructions stored therein forms at least a part of a product including instructions which can be executed to provide means for executing processing procedures or operations specified in the block diagrams. Examples of the computer-readable storage medium may include an electronic storage medium, a magnetic storage medium, an optical storage medium, an electromagnetic storage medium, a semiconductor storage medium, and the like. More specific examples of the computer-readable storage medium may include a floppy (registered trademark) disk, a diskette, a hard disk, a random access memory (RAM), a read only memory (ROM), an erasable programmable read only memory (EPROM or flash memory), an electrically erasable programmable read only memory (EEPROM), a static random access memory (SRAM), a compact disk read only memory (CD-ROM), a digital versatile disc (DVD), a Blu-ray (registered trademark) disc, a memory stick, an integrated circuit card, or the like.

The computer-readable instructions may include an assembler instruction, an instruction-set-architecture (ISA) instruction, a machine instruction, a machine dependent instruction, a microcode, a firmware instruction, state-setting data, or either of source code or object code written in any combination of one or more programming languages including an object oriented programming language such as Smalltalk (registered trademark), JAVA (registered trademark), and C++, and a conventional procedural programming language such as a “C” programming language or a similar programming language.

Computer-readable instructions may be provided to a processor of a general purpose computer, a special purpose computer, or another programmable data processing device, or to programmable circuit, locally or via a local area network (LAN), wide area network (WAN) such as the Internet, and a computer-readable instruction may be executed to provide means for executing operations specified in the described processing procedures or block diagrams. Examples of the processor include a computer processor, a processing unit, a microprocessor, a digital signal processor, a controller, a microcontroller, and the like.

While the present invention has been described by way of the embodiments, the technical scope of the present invention is not limited to the above described embodiments. It is apparent to persons skilled in the art that various alterations or improvements can be made to the above-described embodiments. It is also apparent from description of the claims that the embodiments to which such alterations or improvements are made can be included in the technical scope of the present invention.

The operations, procedures, steps, and stages etc. of each process performed by a device, system, program, and method shown in the claims, specification, or diagrams can be executed in any order as long as the order is not indicated by “before”, “prior to”, or the like and as long as the output from a previous process is not used in a later process. Even if the operation flow is described using phrases such as “first” or “next” for the sake of convenience in the claims, specification, or drawings, it does not necessarily mean that the process must be performed in this order.

### EXPLANATION OF REFERENCES

10 system
80 user
100 input device
140 server
120 movable body
210 input unit
220 processing unit
240 display unit
280 storage unit
290 communication unit
320 processing unit
380 storage unit
390 communication unit
400, 500, 600, 700, 800, 1000 screen
410, 420, 430 vehicle object
440 object
470 object
480 map
2000 computer
2010 host controller
2012 CPU
2014 RAM
2020 input/output controller
2022 communication interface
2024 flash memory
2026 ROM
2040 input/output chip.

What is claimed is:

1. An input device comprising:
a display unit which displays a map including a path along which a movable working machine can travel; and
an input unit for a user to input a first instruction to display an environment object indicating an environment related to the path along with the path on the map displayed on the display unit,
wherein the display unit displays the environment object at a position corresponding to the path on the map when the first instruction is input to the input unit.

2. The input device according to claim 1, wherein the first instruction includes:
an instruction to indicate to start the first instruction; and
an instruction to specify the path displayed along with the environment object on the map.

3. The input device according to claim 1, wherein the input unit further inputs a second instruction for the user to select a particular type of environment related to the path among a plurality of environments of different types.

4. The input device according to claim 3, wherein the input unit inputs a predetermined operation by the user on a position on the path on the map,
the display unit displays options for the user to select a particular type of environment among the plurality of environments when the predetermined operation is input to the input unit, and
the input unit inputs an instruction for the user to select, among the options, a particular type of environment related to the path.

5. The input device according to claim 1, wherein the environment related to the path includes a travel rule on the path.

6. The input device according to claim 5, wherein the travel rule includes at least one of prohibiting entry to the path and limiting a travel speed on the path.

7. The input device according to claim 1, wherein the environment related to the path includes a road surface state on the path.

8. The input device according to claim 1, wherein the input unit further inputs a third instruction from a user to stop displaying the environment object displayed on the display unit, and
the display unit stops displaying the environment object displayed on the map when the third instruction is input to the input unit.

9. The input device according to claim 1, wherein the input unit inputs from the user a position on the map on the path at which the environment object is to be displayed, and
the display unit displays the environment object along with the path on the display unit when the position input to the input unit is off the path on the map and the position input to the input unit is within a predetermined range from the path.

10. The input device according to claim 1, wherein the display unit displays a lattice pattern object by superimposing the lattice pattern object on the map,
the first instruction includes an instruction to specify a position of one compartment of the lattice pattern object, and
the display unit displays the environment object at a position corresponding to the path on the map when at least a part of the path is included within the one compartment of the lattice pattern object instructed by the first instruction.

11. The input device according to claim 1, wherein the movable working machine is an unmanned vehicle which performs autonomous navigation.

12. A server which can communicate with an input device which displays a map including a path along which a movable working machine can travel, wherein
environment information indicating an environment related to the path is input by a user on the map in the input device,
the server includes:
a calculation unit which calculates the path along which the movable working machine travels; and
a communication unit which receives, from the input device, position information indicating a position on the map at which the environment information is input by the user in the input device, and
the calculation unit re-calculates a new path along which the movable working machine should travel based on the position information and position information of the path when the communication unit receives the position information from the input device.

13. The server according to claim 12, wherein the environment related to the path includes a travel rule on the path.

14. The server according to claim 12, wherein the communication unit further:
receives information indicating a state of the path; and
transmits to the input device the map further including information indicating the state of the path when the communication unit receives information indicating the state of the path.

15. The server according to claim 12, wherein the communication unit receives information indicating a state of the path detected by the movable working machine.

16. The server according to claim 15, wherein the information indicating the state of the path includes at least any of information indicating that there is a puddle on the path, information indicating that there is mud on the path, information indicating that there is a bump or dent on the path, and information indicating a degree of a gradient in the path.

17. The server according to claim 12, wherein the movable working machine is an unmanned vehicle which performs autonomous navigation.

18. An input method including:
displaying a map including a path along which a movable working machine can travel;
obtaining, by an input unit, a first instruction from a user on the map which is displayed, wherein the first instruction is to display an environment object indicating an environment related to the path along with the path; and
displaying the environment object at a position corresponding to the path on the map when the first instruction is input.

19. A system comprising:
the input device according to claim 1;
a calculation unit which calculates the path along which the movable working machine travels; and
a communication unit which receives, from the input device, position information indicating a position on the map at which information indicating the environment is input by the user in the input device,
wherein the calculation unit re-calculates a new path along which the movable working machine should travel based on the position information and position information of the path when the communication unit receives the position information from the input device.
